(19) United States
(12) Patent Application Publication
(10) Pub. No.: US 2009/0088174 A1
(43) Pub. Date: Apr. 2, 2009

(54) WIRELESS COMMUNICATION APPARATUS AND METHOD FOR CONTROLLING WIRELESS COMMUNICATION APPARATUS

(75) Inventors: Shohei KIKUCHI, Fuchu-shi (JP); Yasuhiko Tanabe, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/195,547

(22) Filed: Aug. 21, 2008

(30) Foreign Application Priority Data
Sep. 27, 2007 (JP) 2007-252026

(51) Int. Cl. H04Q 7/20

(52) U.S. Cl. 455/450

(57) ABSTRACT

A wireless communication apparatus performs simultaneous communication with a plurality of communication terminals by using the same frequency band. The apparatus including: a reception unit that receives feedback information from each of the communication terminals; an acquisition unit that acquires a correlation value between the latest feedback information and the feedback information previously stored in a storage unit for each of the communication terminals; a measurement unit that measures a delay time relating to the feedback information; a generation unit that generates a reliability parameter representing degree of error that is allowed in the feedback information based on the correlation value and the delay time; and a selection unit that selects two or more of the communication terminals from among the plurality of the communication terminals based on the reliability parameter.

The entire disclosure of Japanese Patent Application No. 2007-252026 filed on Sep. 27, 2007 including specification, claims, drawings and abstract is incorporated herein by reference in its entirety.

### BACKGROUND

1. Field

The present invention relates to a wireless communication apparatus and a method for controlling a wireless communication apparatus.

2. Description of the Related Art

Recently, communication terminals (user terminals) such as cellular phones have been rapidly spread into the market, and it is required to increase the use efficiency of the frequency band thereof. As one method for increasing the use efficiency of the frequency band, there is a spatial division multiple access (SDMA). In the spatial division multiple access, a base station performs communication by simultaneously transmitting different electric waves at the same time and through the same frequency band to the user terminals located in different places by using antennas that can control the directivity of electric waves.

One of factors for determining the communication performance in the spatial division multiple access is how to select user terminals to which the base station transmits electric waves at the same time and through the same frequency band from among a plurality of user terminals, and hereinafter this is referred to as scheduling.

There have been proposed many scheduling methods. As useful one of the scheduling methods, a method in which the base station performs scheduling based on the quality Channel Quality Indicator (CQI) of wireless channels between the base station and the user terminals has been proposed (see US 2005/0043031, for instance).

In technology disclosed in the US 2005/0043031, the base station performs scheduling based on the CQI measured by the user terminals. However, error is included in the CQI measured by the user terminals due to influence of delay time from when each user terminal measures the CQI to when the scheduling is performed or the like, and accordingly, the reliability thereof decreases. In addition, since the lengths of the delay times for each user terminal differ, the reliability of the CQI measured by each user terminal becomes different. In such a situation, the precision of scheduling is markedly deteriorated and the communication performance of the spatial division multiple access is markedly deteriorated.

Thus, a method in which scheduling is performed based on the quality of wireless channels between the base station and the user terminals with a time from when each user terminal is requested for communication to when the base station performs the scheduling considered has been proposed (see JP-A-2006-333199, for instance).

A communication channel between the base station and each user terminal changes by time due to a change of environments between the base station and the user terminal or moving of the user terminal. Since speeds of changes of the environments between the base station and the user terminals and the moving speed of the user terminals differ for each user terminal, the degrees of changes of the communication channels between the base station and the user terminals differ according to each user terminal.

In technology disclosed in JP-A-2006-333199, although the time from when each user terminal is requested for communication to when the base station performs scheduling is considered, different speeds of changes of the communication channels for the user terminals are not considered. Accordingly, scheduling cannot be performed with high precision, and there is a problem that the communication performance of the spatial division multiple access is deteriorated.

### SUMMARY

According to one aspect of the invention, a wireless communication apparatus that performs simultaneous communication with a plurality of communication terminals by using the same frequency band, the apparatus includes: a request unit that requests each of the communication terminals to send feedback information representing conditions of communication channels used in communication; a reception unit that receives the feedback information from the communication terminals; a storage unit that stores the feedback information received by the reception unit; an acquisition unit that acquires a correlation value between the latest feedback information received by the reception unit and the feedback information previously stored in the storage unit for each of the communication terminals; a measurement unit that measures a delay time from when the feedback information is requested from the request unit to when the feedback information is received by the reception unit; a generation unit that generates a reliability parameter representing degree of error that is allowed in the feedback information received from the each of the communication terminals based on the correlation value and the delay time; and a selection unit that selects two or more of the communication terminals from among the plurality of the communication terminals based on the reliability parameter.

### BRIEF DESCRIPTION OF THE DRAWINGS

Embodiment may be described in detail with reference to the accompanying drawings, in which:

FIG. 1 is a diagram showing a wireless communication apparatus according to a first embodiment;

FIG. 2 is a block diagram showing the configuration of the base station according to the first embodiment.

FIGS. 3A and 3B show expressions for calculating a weight matrix by using an SLR norm;

FIG. 4 is a flowchart showing the operation of the base station according to the first embodiment;

FIG. 5 is a block diagram showing the configuration of a multiple user determining unit according to the first embodiment;

FIG. 6 is a flowchart showing the operation of the multiple user determining unit according to the first embodiment;

FIG. 7 is a diagram showing a calculation expression of a correlation value of responses of communication channels;

FIG. 8 is a diagram showing a calculation expression of a reliability parameter;

FIG. 9 is a block diagram showing the configuration of a multiple user determining unit according to a second embodiment;

FIG. 10 is a diagram showing the storage content of a code book converting section;

FIG. 11 is a block diagram showing the configuration of a multiple user determining unit according to a third embodiment; and

FIG. 12 is a diagram showing the storage content of a correlation value storing section.

### DETAILED DESCRIPTION

Hereinafter, embodiments of the present invention will be described.

### First Embodiment

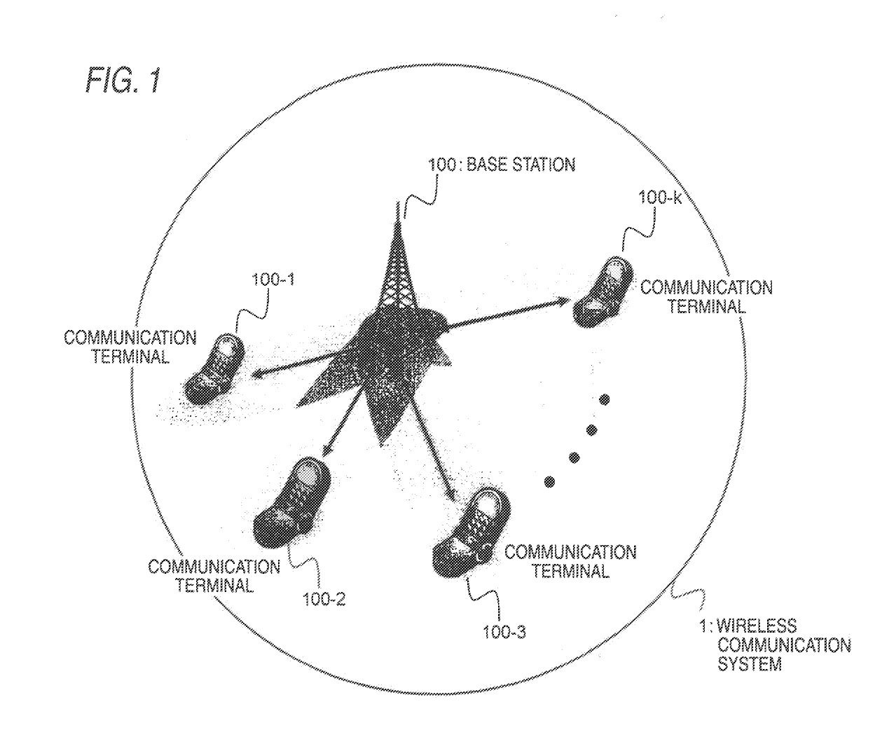

FIG. 1 is a diagram showing a wireless communication apparatus 1 according to a first embodiment. The wireless communication apparatus 1 according to the first embodiment has a base station 100 and a plurality of communication terminals 100-1 to 100-K.

The base station 100 transmits different electric waves at the same time and through the same frequency band by using a spatial division multiple access to a plurality of communication terminals that are located in different places. The base station 100 requests the communication terminals 100-1 to 100-K to transmit feedback information for performing scheduling of the spatial division multiple access, that is, selecting communication terminals to which electric waves are simultaneously transmitted at the same time through the same frequency band.

The feedback information is information from which the response of a communication channel can be predicted by the base station 100 in a case where the feedback information is received by the base station 100. For example, the feedback information may be information representing the response of a communication channel, information representing the quantized response of a communication channel, compressed and encoded information representing the response of a communication channel, or specific pattern information from which the response of a communication channel can be predicted in a case where the feedback information is received by the base station 100.

The communication terminals 100-1 to 100-K communicate with the base station 100. In FIG. 1, although cellular phones are shown as examples of the communication terminals 100-1 to 100-K, however, the communication terminals may be information processing devices such as Personal Digital Assistants (PDAs) or PCs that can receive electric waves. The communication terminals 100-1 to 100-K send feedback information back every time when the feedback information is requested from the base station 100.

Hereinafter, the feedback information is information representing the response of a communication channel between the base station 100 and each one of the communication terminals 100-1 to 100-K.

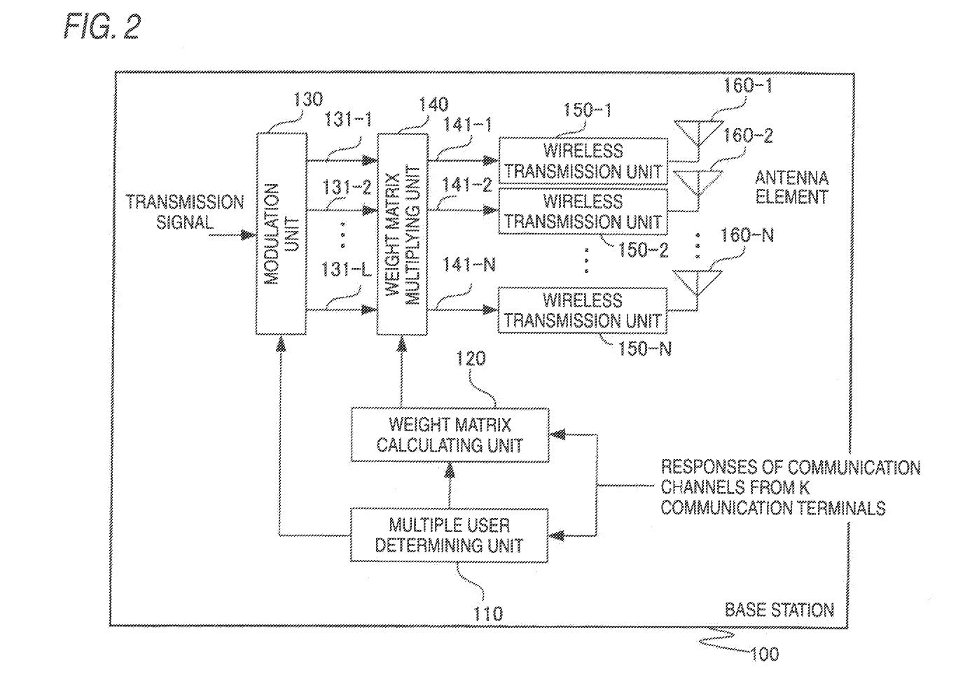

FIG. 2 is a block diagram showing the configuration of the base station 100 according to a first embodiment.

The base station 100 according to the first embodiment includes a multiple user determining unit 110, a weight matrix calculating unit 120, a modulation unit 130, a weight matrix multiplying unit 140, wireless transmission units 150-1 to 150-N, and antenna elements 160-1 to 160-N.

N (here, N is an integer equal to or larger than one) antenna elements 160-1 to 160-N configure an array antenna. The base station 100 transmits electric waves of L (here, L is an integer that is equal to or larger than K and is equal to or smaller than N) signals to the communication terminals at the same time and through the same frequency band based on responses of communication channels transmitted from K (here, K is an integer equal to or larger than one) communication terminals 100-1 to 100-K. The base station 100 may transmit a plurality of signals to one communication terminal.

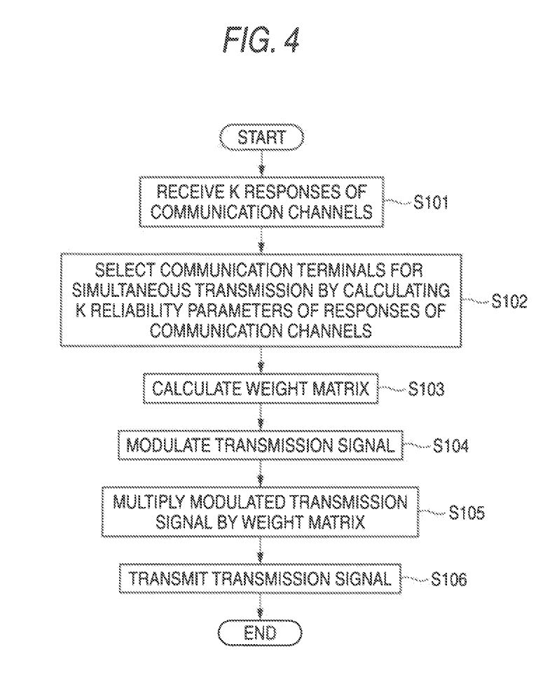

FIG. 4 is a flowchart showing the operation of the base station 100 according to the first embodiment.

First, the base station 100 requests the K communication terminals 100-1 to 100-K to transmit the responses of communication channels. The K communication terminals 100-1 to 100-K transmit the responses of the communication channels between the communication terminals and the base station 100 to the base station 100. The base station 100 receives the responses of the communication channels from the K communication terminals 100-1 to 100-K (Step S101). The responses of the communication channels which have been received from the K communication terminals 100-1 to 100-K are input to the multiple user determining unit 110 and the weight matrix calculating unit 120 of the base station 100.

Next, the multiple user determining unit 110 calculates reliability parameter representing reliability levels of K responses of the communication channels based on the input K responses of the communication channels and selects L communication terminals to which electric waves are simultaneously transmitted at the same time and through the same frequency band based on the reliability parameter (Step S102). A method for calculating the reliability parameter by using the multiple user determining unit 110 and a method for selecting L communication terminals that simultaneously transmit electric waves at the same time and through the same frequency band will be described later. The multiple user determining unit 110 outputs information representing the reliability parameter and the L communication terminals to the weight matrix calculating unit 120, and outputs information representing the selected L communication terminals to the modulation unit 130.

Next, the weight matrix calculating unit 120 calculates a weight matrix of beam forming using input information representing the K responses of the communication channels, the reliability parameter, and the L communication terminals (Step S103). The weight matrix calculating unit 120, in order to transmit electric waves having directivity for a given direction, calculates weight matrixes, which are used for determining the amplitudes and phases of electric waves output from N antenna terminals, for the L communication terminals.

As a method for calculating the weight matrix by using the response of the communication channel between the base station 100 and each one of the communication terminals 100-1 to 100-K and the reliability parameter, a method for maximizing an Signal to Leakage Ratio (SLR) norm by using a covariance matrix (secondary statistical amount) of the communication channel is used. The above-described method for calculating the weight matrix is only an example, and any other method may be used.

Here, the feedback information that is received by the base station 100 from each one of the communication terminals 100-1 to 100-K, that is, the response of the communication channel between the base station 100 and each one of the communication terminals 100-1 to 100-K includes error, and the reliability parameter represents the degree of the error that can be included in the response of the communication channel.

The SLR represents, in the spatial division multiple access, a ratio of a power level of an electric wave arriving at one communication terminal that is one of transmission destinations to a power level of electric waves that leak in other communication terminals performing spatial division multiple access. By maximizing the SLR, interference that occurs in a case where the base station 100 simultaneously transmits electric waves at the same time through the same frequency band can be minimized.

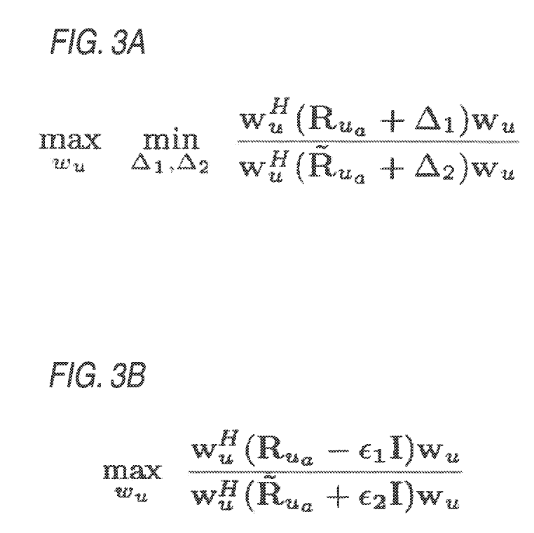

FIG. 3A shows an expression for acquiring a weight matrix by using an SLR norm. FIG. 3B shows an expression acquired by transforming the expression that is used for calculating the weight matrix by using the SLR norm.

Here, “wᵤ” denotes a weight matrix, “Rᵤₐ” denotes a covariance matrix for a response of a communication channel between the base station 100 and a communication terminal of a transmission destination, and “R˜ᵤₐ” is a covariance matrix of a response of a communication channel between the base station 100 and communication terminals other than the transmission destination. In addition, “Δ₁” denotes error included in “Rᵤₐ”, and “Δ₂” denotes error included in “R˜ᵤₐ”.

Here, error “Δ₁” and error “Δ₂” are set based on the reliability parameter. The error “Δ₁” is included in the covariance matrix of the response of the communication channel between the base station 100 and the communication terminal of the transmission destination. The error “Δ₂” is included in the covariance matrix of the response of the communication channels between the base station 100 and the communication terminals other than the transmission destination.

For example, by determining the upper bounds of errors “←₁” and “Δ₂” as upper bounds “ε₁” and “ε₂” based on the reliability parameter, the expression shown in FIG. 3A can be changed into an expression shown in FIG. 3B. The weight matrix “wᵤ” can be calculated based on the expression shown in FIG. 3B.

As described above, a robust weight matrix with the errors of the responses of the communication channels considered can be calculated, by using the information (reliability parameter) representing degree of errors of the responses of communication channels for calculating the weight matrix by using the responses of the communication channels between the base station 100 and the communication terminals 100-1 to 100-K.

Then, the weight matrix calculating unit 120 outputs the calculated weight matrix to the weight matrix multiplying unit 140.

Next, the modulation unit 130 modulates transmission data that is transmitted to the communication terminals by the base station 100 by using the input information representing L communication terminals (Step S104). The modulation unit 130 outputs the transmission data 131-1 to 131-L for which the modulation operation has been performed to the weight matrix multiplying unit 140.

Next, the weight matrix multiplying unit 140 multiplies the input transmission data 131-1 to 131-L, for which the modulation operation has been performed, by the weight matrixes for the L communication terminals (Step S105). The weight matrix multiplying unit 140 distributes and outputs the results 141-1 to 141-N of multiplication to N wireless transmission units 150-1 to 150-N.

Next, the N wireless transmission units 150-1 to 150-N output signals generated by performing pre-transmission operation for the input results 141-1 to 141-N of multiplication to the antenna elements 160-1 to 160-N. The N antenna elements 160-1 to 160-N perform transmission operation for the transmission data by emitting the signals output from the N wireless transmission units 150-1 to 150-N as electric waves (Step S106).

As described above, electric waves are simultaneously transmitted from the N antenna elements 160-1 to 160-N of the base station 100 to the K communication terminals at the same time and through the same frequency bandwidth.

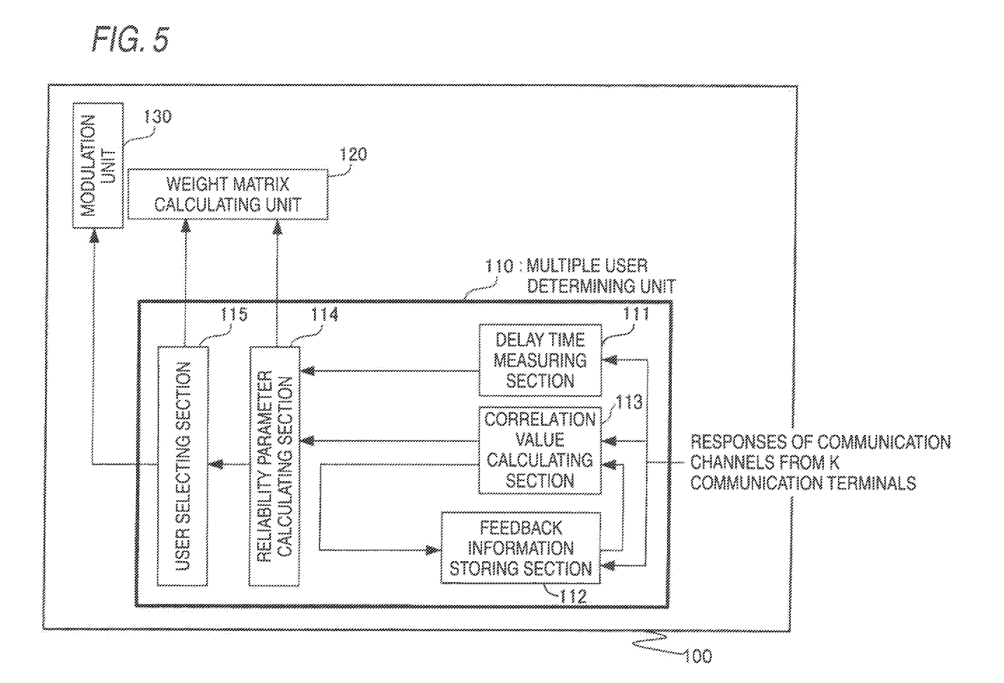

FIG. 5 is a block diagram showing the multiple user determining unit 110.

The multiple user determining unit 110 includes a delay time measuring section 111, a feedback information storing section 112, a correlation value calculating section 113, a reliability parameter calculating section 114, and a user selecting section 115.

The responses of communication channels from the K communication terminals 100-1 to 100-K are input to the delay time measuring section 111, the feedback information storing section 112, and the correlation value calculating section 115. The reliability parameter calculating section 114 outputs the reliability parameter to the weight matrix calculating unit 120. The user selecting section 115 outputs the result (the information representing the L communication terminals) of selecting the L communication terminals to which electric waves are simultaneously transmitted at the same time and through the same channel to the weight matrix calculating unit 120 and the modulation unit 130.

The delay time measuring section 111 measures delay times “dₖ” (here, k is an integer equal to or larger than one and equal to or small than K) from when the K communication terminals 100-1 to 100-K are requested to transmit the responses (feedback information) of communication channels to when the responses of the communication channels transmitted from the K communication terminals 100-1 to 100-K are received. The timings for requesting the K communication terminals 100-1 to 100-K to transmit the responses of the communication channels may depend on each communication terminal. In such a case, the delay time measuring section 111 is configured to measure the delay times “dₖ” from when the K communication terminals are individually requested to transmit the responses of the communication channels to when the responses of the communication channels transmitted from the K communication terminals 100-1 to 100-K are received.

The feedback information storing section 112 stores the responses of the communication channels which have been transmitted from the K communication terminals 100-1˜100-K. The feedback information storing section 112 stores the responses of the communication channels which have been transmitted from the K communication terminals 100-1 to 100-K at least for one time division.

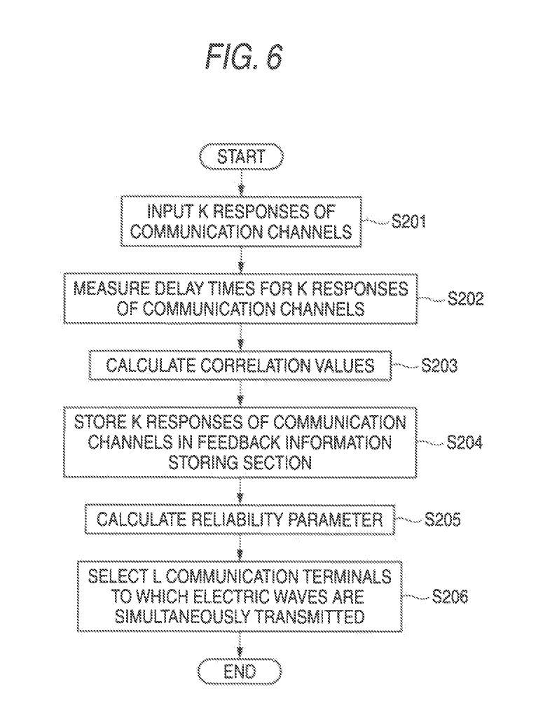

FIG. 6 is a flowchart showing the operation of the multiple user determining unit 110.

First, the responses of the communication channels which have been received from the K communication terminals 100-1 to 100-K are input to the delay time measuring section 111, the feedback information storing section 112 and the correlation value calculating section 113 (Step S201).

Here, the delay time measuring section 111 measures times elapsed after requests for transmitting the responses of the communication channels to the K communication terminals 100-1 to 100-K. When the response of the communication channel is input, the delay time measuring section 111 determines the elapsed time at the timing when the response of the communication channel is input, as the delay time “dₖ” of the response of the communication channel (Step S202). After the K responses of the communication channels are input and the delay time for each of the communication channels is determined, the delay time measuring section 111 outputs the delay times “dₖ” of the K responses of the propagation cannels to the reliability parameter calculating section 114.

Next, the correlation value calculating section 113 calculates the correlation values “αₖ” between the input K latest responses of the communication channels and K old responses of the communication channels previously stored in the feedback information storing section 112, for each of the communication terminals 100-1 to 100-K (Step S203). The correlation value calculating section 113 reads out old response of a communication channel. The old response of a communication channel is a response of a communication channel transmitted from the same communication terminal as the communication terminal that is a transmission source of the input latest response of the communication channel. The old response of a communication channel was input to the multiple user determining unit 110 in advance and is stored in the feedback information storing section 112. The correlation value calculating section 113 calculates a correlation value “ski between the input latest response of the communication channel and the old response of the communication channel read out from the feedback information storing section 112. It is assumed that the old responses of the communication channels are input to the user determining unit 110 earlier than the latest responses of the communication channels by a certain time “τₖ”.

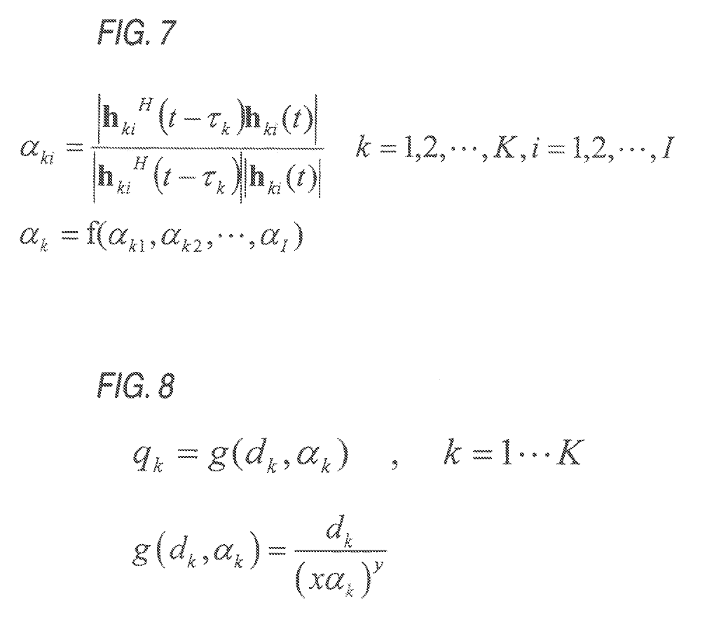

FIG. 7 is a diagram showing equations used by the correlation value calculating section 113 for calculating the correlation values “αₖ” between the latest responses Hₖ(t)=[hₖₗ(t) . . . h_{kI}(t)] of the communication channels and the old responses Hₖ(t−τₖ)=[hₖₗ(t−τₖ) . . . h_{kI}(t−τₖ)] of the communication channels. It is assumed that all the communication terminals 100-1 to 100-K have “I” antenna terminals. However, the communication terminals 100-1 to 100-K may have different numbers of the antenna terminals. A function “f” is for acquiring a correlation value “αₖ” for the responses of the communication channels which are originated from all the antennas of each of the communication terminals 100-1 to 100-K based on the correlation values “αₖᵢ” that are calculated based on the responses of the communication channels originated from the antenna terminals of each of the communication terminals 100-1 to 100-K.

The correlation values “αₖ” between the latest responses Hₖ(t)=[hₖₗ(t) . . . h_{kT}(t)] of the communication channels and the old responses Hₖ(t−τₖ)=[hₖₗ(t−τₖ) . . . [hₖₗ(t−τₖ)] of the communication channels take a value in the range of “0” to “1”. As the correlation value “αₖ” approaches “0”, the correlation become weaker. On the other hand, as the correlation value “αₖ” approaches “1”, the correlation becomes stronger.

The correlation value calculating section 113 outputs the calculation results of the correlation values “αₖ” between the input latest responses of the communication channels and the old responses of the communication channels which have been read out from the feedback information storing section 112 to the reliability parameter calculating section 114.

Next, the feedback information storing section 112 stores the K latest responses of the communication channels (Step S204). Here, when calculation of the correlation values are completed by the correlation value calculating section 113, the old responses of the communication channels are not needed, and accordingly, the old responses of the communication channels may be overwritten with the input latest responses of the communication channels or may be deleted.

Next, the reliability parameter calculating section 114 calculates the K reliability parameter “qₖ” by using the K delay times “dₖ” of the communication channel responses output from the delay time measuring section 111 and the K correlation values “αₖ” output from the correlation value calculating section 113 (Step S205). The reliability parameter is information that represents the reliability of each of the responses of the communication channels received from the K communication terminals 100-1 to 100-K. As the reliability parameter decreases, the error included in the response of the communication channel becomes smaller. On the other hand, as the reliability parameter increases, the error included in the response of the communication channel becomes larger.

FIG. 8 is a diagram showing equations used by the reliability parameter calculating section 114 for calculating the reliability parameter “qₖ” by using the delay time “dₖ” and the correlation value “αₖ”. Here, “x” is a real number larger than “0”, and “y” is a real number equal to or larger than “0”. The values of “x” and “y” are determined by the environments or characteristics of the wireless communication system 1. Here, in the equations shown in FIG. 8, the reliability parameter calculating section 114 is assumed to calculate the reliability parameter “qₖ” by using equations acquired by setting the values of “x” and “y” to “1”. The equations used in calculating the reliability parameter “qₖ” are not limited to those shown in FIG. 8.

The reliability parameter calculating section 114 outputs the calculation results “qₖ” of the reliability parameter using the K delay times “dₖ” of the responses of the communication channels output from the delay time measuring section 111 and the K correlation values “αₖ” output from the correlation value calculating section 113 to the user selecting section 115 and the weight matrix calculating unit 120.

Next, the user selecting section 115 selects L communication terminals that simultaneously transmit electric waves at the same time and through the same frequency band from among the K communication terminals 100-1 to 100-K by using the input reliability parameter “qₖ” (Step S206). The user selecting section 115 selects L communication terminals in the descending order of magnitudes of the reliability parameter “qₖ” representing the reliability of the responses of the communication channels which have been received form the K communication terminals 100-1 to 100-K.

The method for selecting L communication terminals that simultaneously transmit electric waves at the same time and through the same frequency band by using the user selecting section 115 is not limited to that described above. L terminals are selected such that differences of the reliability parameter of the responses of the communication channels which have been received from the L communication terminals become small. In addition, the user selecting section 115 preferentially selects a communication terminal that is a transmission source of feedback information in which the degree of error included in the reliability parameter is large as a communication terminal that performs simultaneous communication through the same frequency band. The user selecting section 115 outputs information representing the L communication terminals to the weight matrix calculating unit 120 and the modulation unit 130.

As described above, the base station 100 according to the first embodiment can predict the degree of changes of the responses of the communication channel by time, by calculating a correlation value between the latest response of the communication channel and the old response of the communication channel, which is a response a certain time earlier, that are transmitted from the same communication terminal.

In addition, by calculating a reliability parameter representing the reliability of a response of a communication channel based on a delay time from when the communication terminal is requested for the response of the communication channel to when the response of the communication channel is received and the degree of changes of responses of the communication channel by time, the degree of the error included in the response of the communication channel can be predicted.

Accordingly, the base station 100 can select L communication terminals to which electric waves are simultaneously transmitted at the same time and through the same frequency band by using the responses of the communication channels of which the degrees of errors are known. Consequently the quality of communication, and more particularly, the system capacity in a spatial division multiple access can be improved.

In addition, as the feedback information that is transmitted from the communication terminals 100-1 to 100-K to the base station 100, not information representing the responses of the communication channels but information representing the quantized responses of the communication channels generated by compressing and coding the information representing the responses of the communication channels is used. Accordingly, the amount of information of the feedback information can be reduced, and the bandwidth required for transmission of the feedback information can be reduced.

Although the weight matrix calculating unit 120 has been described to calculate the weight matrix of the beamforming by using the input K responses of the communication channels and the K reliability parameter. However, the weight matrix calculating unit 120 may calculate the weight matrix of the beam forming not by using the reliability parameter but by using only the input K responses of the communication channels.

In such a case, although the deterioration of the quality of communication in the spatial division multiple access cannot be avoided, however, the amount of calculation required for calculating the weight matrix can be reduced. For example, when a base station 100 is configured to have a simple configuration, changes of communication channels between the base station 100 and the communication terminals 100-1 and 100-K are small, or the like, the amount of calculation required for calculating the weight matrix can be markedly reduced while the deterioration of the quality of communication in the spatial division multiple access is suppressed.

In addition, the base station 100 may transmit data using a multi carrier transmission method such as an Orthogonal Frequency Division Multiplexing (OFDM) method.

In such a case, the reliability parameter calculating section 114 regards one sub carrier as one communication channel and calculates the reliability parameter representing the reliability of responses of the communication channels for each sub carrier based on delay time from when the communication terminals 100-1 to 100-K are requested for the responses of the communication channels to when the responses of the communication channels are received and the degree of changes of the responses of the communication channels by time. Then, the reliability parameter calculating section 114 sets the reliability parameter of the responses of the communication channels transmitted from the communication terminals 100-1 to 100-K to averages of the reliability parameter of each sub carrier. In addition, for calculating the reliability parameter of the responses of the communication channels transmitted from the communication terminals 100-1 to 100-K, the reliability parameter calculating section 114 may use maximum values of the reliability parameter of each sub carrier or the results of weighted averages of the reliability parameter of each sub carrier, instead of the averages of the reliability parameter of each sub carrier. In such a case, weighting factors of the reliability parameter of each sub carrier may be determined, for example, based on the SN ratios of the sub carriers.

Accordingly, even when data is transmitted using a multi carrier transmission method such as an OFDM method, the base station 100 can select communication terminals to which electric waves are simultaneously transmitted at the same time and through the same frequency bandwidth with influence of changes of the communication channels with time considered.

In addition, the multiple user determining unit 110, for example, may be implemented by using a general-purpose computer device as basic hardware. In other words, the delay time measuring section 111, the correlation value calculating section 113, the reliability parameter calculating section 114, and the user selecting section 115 may be implemented by executing a program in a processor built in the computer device. In such a case, the multiple user determining unit 110 may be implemented by installing the program to the computer device in advance or be implemented by storing the program in a storage medium such as a CD-ROM or distributing the program through a network and appropriately installing the program to the computer device. In addition, the feedback information storing section 112 may be implemented by appropriately using a storage medium such as a memory that is internally installed to the computer device or is externally attached to the computer device, a hard disk, a CD-R, a CD-RW, a DVD-RAM, or a DVD-R.

### Second Embodiment

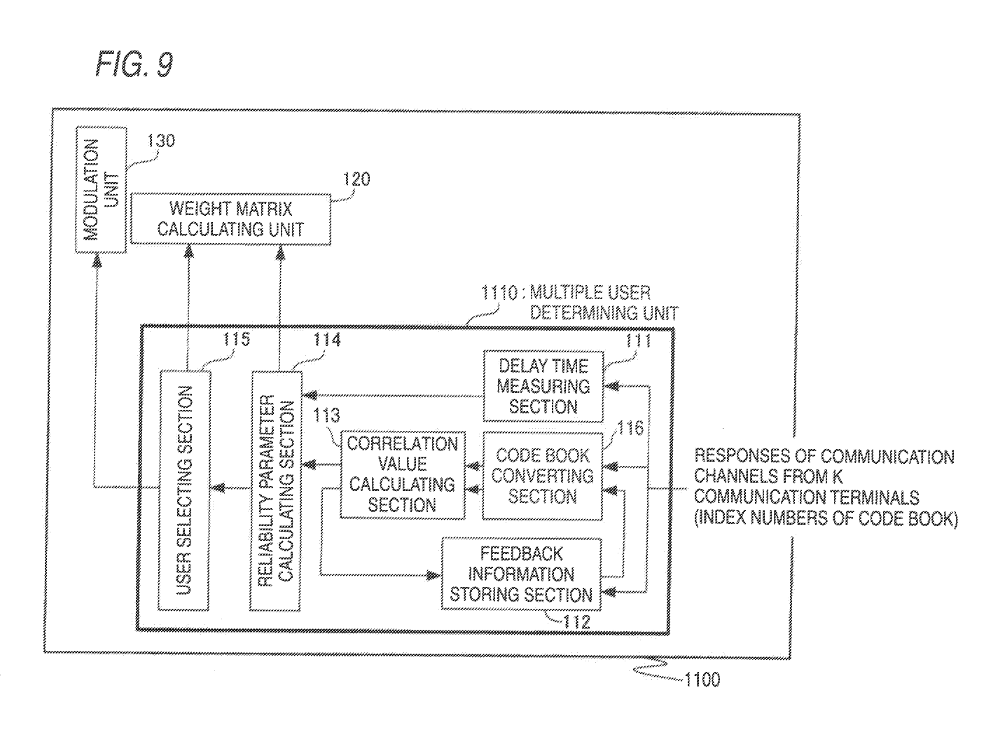

FIG. 9 is a block diagram showing the configuration of a multiple user determining unit 1110 according to a second embodiment. To the same part of the multiple user determining unit 1110 according to the second embodiment as that of the multiple user determining unit 110 according to the first embodiment, the same reference sign is attached, and a description thereof is omitted here.

In the wireless communication system according to the second embodiment, the feedback information that is transmitted and received between a base station 1100 and each of the communication terminals 100-1 to 100-K is an index number of a code book, which is different from the wireless communication system 1 according to the first embodiment. The base station 1100 and the communication terminals 100-1 to 100-K store the same code book. The code book is a database of the responses of the communication channels in which index numbers and various responses of the communication channels are associated.

In addition, the multiple user determining unit 1110 of the base station 1100 according to the second embodiment has an additional code book converting section 116, which is different from the multiple user determining unit 110 according to the first embodiment.

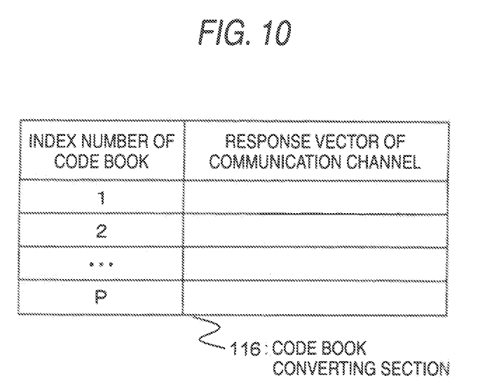

FIG. 10 is a diagram showing the correspondence, which is stored in the code book converting section 116, between index numbers 1 to P (where P is an integer equal to or larger than 2) and the response vectors of the communication channels.

When receiving an input of an index number, the code book converting section 116 outputs a response vector of the communication channel corresponding to the index number in accordance with the correspondence shown in FIG. 10.

Then, the delay time measuring section 111 measures delay times “dₖ” from when K communication terminals 100-1 to 100-K are requested to transmit the feedback information to when index numbers of the code book transmitted from the K communication terminals 100-1 to 100-K are received. Then, the feedback information storing section 112 stores the index numbers of the code book transmitted from the K communication terminals 100-1 to 100-K.

Only Step S203 of the operation of the multiple user determining unit 1110 according to the second embodiment shown in FIG. 6 is different from that of the multiple user determining unit 110 according to the first embodiment. Thus, hereinafter, Step S203 of the operation of the multiple user determining unit 1110 according to the second embodiment shown in FIG. 6 will be described.

First, when requested to transmit the feedback information from the base station 1100, the communication terminals 100-1 to 100-K transmit index numbers for designating responses of the communication channels which are closest to the predicted responses of the communication channels between the base station 1100 and the communication terminals 100-1 to 100-K to the base station 1100. The index numbers received from the K communication terminals 100-1 to 100-K are input to the code book converting section 116. In addition, old index numbers stored in the feedback information storing section 112 and previously received from the K communication terminals 100-1 to 100-K are input to the code book converting section 116.

Next, the code book converting section 116 outputs response vectors of the communication channels corresponding to the input latest index numbers and the old index numbers to the correlation value calculating section 113.

Next, the correlation value calculating section 113 calculates correlation values “αₖ” between the response vectors corresponding to the latest index numbers received from the code book converting section 116 and the response vectors of the communication channels corresponding to the old index numbers.

Next, the correlation value calculating section 113 outputs the calculated correlation values “αₖ” to the reliability parameter calculating section 114.

As described above, by using the index numbers of the code book as the feedback information that is transmitted from the communication terminals 100-1 to 100-K to the base station 100, the amount of information of the feedback information can be reduced to several bits. Accordingly, the communication bandwidth required for transmission of the feedback information can be markedly reduced.

In addition, since the feedback information storing section 112 stores the responses of the communication channels which have been previously received from the K communication terminals 100-1 to 100-K as the index numbers of the code book, the amount of storage can be markedly reduced.

### Third Embodiment

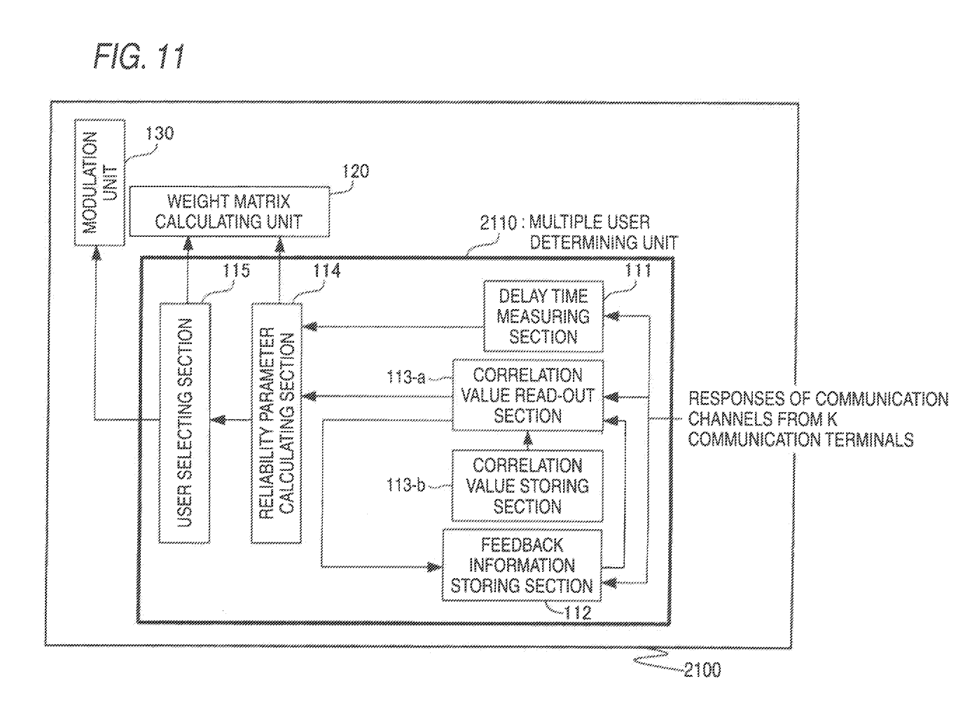

FIG. 11 is a block diagram showing the configuration of a multiple user determining unit 2110 according to a third embodiment. To the same part of the multiple user determining unit 2110 according to the third embodiment as that of the multiple user determining unit 110 according to the first embodiment, the same reference sign is attached, and a description thereof is omitted here.

In the wireless communication system according to the third embodiment, the feedback information that is transmitted and received between a base station 2100 and each of the communication terminals 100-1 to 100-K is an index number of a code book, which is different from that of the first embodiment. The base station 100 and the communication terminals 100-1 to 100-K store the same code book.

In addition, the wireless communication system 1 according to the third embodiment does not have the correlation value calculating section 113 and has a correlation value read-out section 113-a and a correlation value storing section 113-b, which is different from that of the first embodiment.

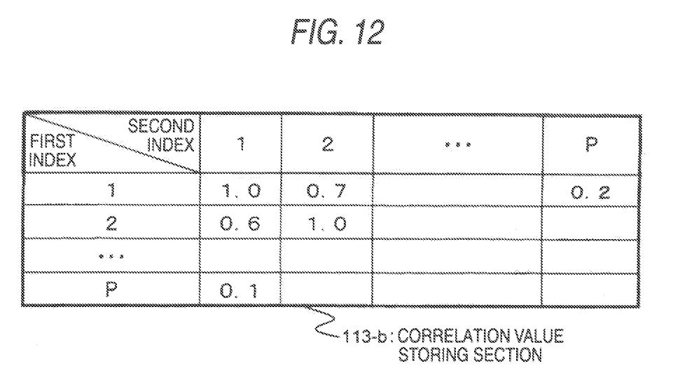

FIG. 12 is a diagram showing the content stored in the correlation value storing section 113-b.

The correlation value storing section 113-b stores correlation values in accordance with two input index numbers (hereinafter, referred to as a first index number and a second index number). The correlation value storing section 113-b stores a correlation value of “1.0” between responses of the communication channels designated by the index number “1” as a correlation value for a case where both the first and second index numbers are “1”. On the other hand, the correlation value storing section 113-b stores a correlation value of “0.7” between responses of the communication channels designated by the index numbers “1” and “2” as a correlation value for a case where the first index number is “1” and the second index number is “2”. On the other hand, the correlation value storing section 113-b stores a correlation value of “0.6” between responses of the communication channels designated by the index numbers “2” and “1” as a correlation value for a case where the first index number is “2” and the second index number is “1”.

Only Step S203 of the operation of the multiple user determining unit 2110 according to the third embodiment shown in FIG. 6 is different from that of the multiple user determining unit 110 according to the first embodiment. Thus, hereinafter, Step S203 of the operation of the multiple user determining unit 2110 according to the third embodiment shown in FIG. 6 will be described.

First, when requested to transmit the feedback information from the base station 100, the communication terminals 100-1 to 100-K transmit index numbers for designating responses of the communication channels which are closest to the predicted responses of the communication channels between the base station 100 and the communication terminals 100-1 to 100-K to the base station 100. The index numbers received from the K communication terminals 100-1 to 100-K are input to the correlation value read-out section 113-a.

Next, the correlation value read-out section 113-a reads out correlation values “αₖ” from the correlation value storing section 113-b by using the input latest index numbers and the old index numbers previously stored in the feedback information storing section 112. In addition, the correlation value read-out section 113-a reads out the old index numbers that have been transmitted from same communication terminals as communication terminals that are transmission sources of the input latest index numbers and have been input to the multiple user determining unit 2110 and stored in the feedback information storing section 112 in advance. The correlation value read-out section 113-a reads out from the correlation value storing section 113-b the correlation values “αₖ” between the responses of the communication channels designated by using the latest index numbers and the responses of the communication channels designated by the old index numbers by using the input latest index numbers and the old index number read out from the feedback information storing section 112.

Next, the correlation value read-out section 113-a outputs the correlation values “αₖ” read out from the correlation value storing section 113-b to the reliability parameter calculating section 114.

As described above, the base station 2100 according to the third embodiment stores the correlation values for combinations of index numbers of the code book in advance. Accordingly, the correlation values between the latest responses (index numbers) of the communication channels and the old responses (index numbers) of the communication channels received a certain time earlier which have been transmitted from the same communication terminal can be read out from the feedback information storing section 112 to be determined without performing calculation operation. Therefore, the load for the calculation operation of the base station 2100 can be markedly reduced.

It is to be understood that the present invention is not limited to the specific embodiments described above and that the present invention can be embodied with the components modified without departing from the spirit and scope of the present invention. The present invention can be embodied in various forms according to appropriate combinations of the components disclosed in the embodiments described above. For example, some components may be deleted from the configurations as described as the embodiments. Further, the components in different embodiments may be used appropriately in combination.

What is claimed is:

1. A wireless communication apparatus that performs simultaneous communication with a plurality of communication terminals by using the same frequency band, the apparatus comprising:
a request unit that requests each of the communication terminals to send feedback information representing a status of a communication channel used in communication;
a reception unit that receives the feedback information from the communication terminals;
a storage unit that stores the feedback information received by the reception unit;
an acquisition unit that acquires a correlation value between the latest feedback information received by the reception unit and the feedback information previously stored in the storage unit for each of the communication terminals;
a measurement unit that measures a delay time from when the feedback information is requested from the request unit to when the feedback information is received by the reception unit;
a generation unit that generates a reliability parameter representing degree of error that is allowed in the feedback information received from the each of the communication terminals based on the correlation value and the delay time; and
a selection unit that selects two or more of the communication terminals from among the plurality of the communication terminals based on the reliability parameter.

2. The apparatus according to claim 1, wherein the generation unit calculates the reliability parameter qₖ of a k-th communication terminal by using the following expression (1) based on the correlation value αₖ and the delay time dₖ, where k is an integer equal to or larger than two, x is a real number larger than zero, y is a real number equal to or larger than zero, and K is the number of the communication terminals.
$${q}_{k} = \frac{{d}_{k}}{{( x {α}_{k} )}^{y}} ( k = 1 … K ) \qquad ( 1 )$$

3. The apparatus according to claim 1 further comprising a second storage unit that stores a correlation value between two feedback information associated with a combination of the two feedback information,
wherein the acquisition unit reads out the correlation value from the second storage unit by using the latest feedback information received by the reception unit and the feedback information previously stored in the storage unit.

4. The apparatus according to claim 1 further comprising:
a transmission unit that transmits directional signals by emitting the electric waves from a plurality of antennas; and
a calculation unit that calculates respective weights of electric waves emitted from the plurality of antennas by using the feedback information transmitted by the communication terminals.

5. The apparatus according to claim 4, wherein the calculation unit calculates the transmission weights by using the feedback information and the reliability parameter for each of the communication terminals.

6. The apparatus according to claim 1, wherein the selection unit selects communication terminals in descending order of the degree of error represented by the reliability parameter which is allowed in the feedback information received from the communication terminals.

7. A method for controlling a wireless communication apparatus that performs simultaneous communication with a plurality of communication terminals by using the same frequency band, the method comprising:
requesting each of the communication terminals to send feedback information representing a status of a communication channel used in communication;
receiving the feedback information from the communication terminals;
storing the received feedback information in a storage unit;
acquiring a correlation value between the received latest feedback information and the feedback information previously stored in the storage unit for each of the communication terminals;
measuring a delay time from when the feedback information is requested to when the feedback information is received;
generating a reliability parameter representing degree of error that is allowed in the feedback information received from the each of the communication terminals based on the correlation value and the delay time; and
selecting two or more of the communication terminals from among the plurality of the communication terminals based on the reliability parameter.

8. A computer-readable program product for causing a processor of a wireless communication apparatus that performs simultaneous communication with a plurality of communication terminals by using the same frequency band to perform processing comprising:
requesting each of the communication terminals to send feedback information representing a status of a communication channel used in communication;
receiving the feedback information from the communication terminals;
storing the received feedback information in a storage unit;
acquiring a correlation value between the received latest feedback information and the feedback information previously stored in the storage unit for each of the communication terminals;
measuring a delay time from when the feedback information is requested to when the feedback information is received;
generating a reliability parameter representing degree of error that is allowed in the feedback information received from the each of the communication terminals based on the correlation value and the delay time; and
selecting two or more of the communication terminals from among the plurality of the communication terminals based on the reliability parameter.
